(19) United States
(12) Patent Application Publication
(10) Pub. No.: US 2025/0278198 A1
(43) Pub. Date: Sep. 4, 2025

(54) INTERFACE TECHNIQUES FOR MULTI-CHANNEL MEMORY DEVICES

(71) Applicant: Micron Technology, Inc., Boise, ID (US)

(72) Inventors: Simone Levada, Munich (DE); Manuel Mencarelli, München (DE); Filippo Vitale, Dachau (DE)

(21) Appl. No.: 19/050,816

(22) Filed: Feb. 11, 2025

Related U.S. Application Data
(60) Provisional application No. 63/560,456, filed on Mar. 1, 2024.

(51) Int. Cl. G06F 3/06; G06F 1/06

(52) U.S. Cl. CPC G06F 3/0616; G06F 1/06; G06F 3/0659; G06F 3/0673

(57) ABSTRACT

Methods, systems, and devices for interface techniques for multi-channel memory devices are described. A memory device may be configured with multiple channels (e.g., channel sets) that can be operated in different modes, such as a standard mode and an evaluation mode. In a standard mode, the memory device may be configured to decode access commands using signals communicated via command/address terminals of a single channel. In an evaluation mode, the memory device may be configured to decode access commands using signals communicated via command/address terminals of both a first channel and a second channel (e.g., of a channel pair). In some examples, the evaluation mode may support relatively faster decoding and faster access operations (e.g., in accordance with fewer clock cycles), which may support evaluation of relatively fast access operation speeds while being operated in accordance with a relatively slow clock signal.

### CROSS REFERENCE

The present Application for Patent claims priority to U.S. Patent Application No. 63/560,456 by Levada et al., entitled “INTERFACE TECHNIQUES FOR MULTI-CHANNEL MEMORY DEVICES,” filed Mar. 1, 2024, which is assigned to the assignee hereof, and which is expressly incorporated by reference in its entirety herein.

### TECHNICAL FIELD

The following relates to one or more systems for memory, including interface techniques for multi-channel memory devices.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports interface techniques for multi-channel memory devices in accordance with examples as disclosed herein.

FIGS. 2 and 3 show examples of architectures that support interface techniques for multi-channel memory devices in accordance with examples as disclosed herein.

FIGS. 4A and 4B show signaling schemes that support interface techniques for multi-channel memory devices in accordance with examples as disclosed herein.

FIG. 5 shows a block diagram of a memory system that supports interface techniques for multi-channel memory devices in accordance with examples as disclosed herein.

FIG. 6 shows a block diagram of a host system that supports interface techniques for multi-channel memory devices in accordance with examples as disclosed herein.

FIGS. 7 and 8 show flowcharts illustrating a method or methods that support interface techniques for multi-channel memory devices in accordance with examples as disclosed herein.

### DETAILED DESCRIPTION

In some memory systems, a memory device may be configured with multiple channel sets. For example, each channel set may each include a command and address channel (e.g., a CA channel), a data channel (e.g., a DQ channel, an I/O channel), and one or more clock channels (e.g., a write clock channel, such as a WCK channel, a read clock channel, such as an RCK channel, or a combination thereof) that support coordinated signaling between the memory device and a host system. Each of the channel sets may be configured for communication of access commands and corresponding data (e.g., write data, read data) and, in some examples, may be associated with accessing a respective memory array of the memory device. For example, a first channel set may support communication of access commands being performed on a first memory array and a second channel set may support communication of access commands being performed on a second memory array. In some cases (e.g., during device testing), it may be beneficial for the memory device to operate relatively quickly (e.g., in accordance with fewer clock cycles, to evaluate relatively fast internal timings or delays) despite the memory device being operated in accordance with relatively slow clock signaling (e.g., from a host system, from an evaluation system).

In accordance with examples described herein, a memory device may also be configured to receive access commands via command and address terminals associated with both a first channel set and a second channel set (e.g., of a pair of channel sets) that may otherwise be received via command and address terminals associated with a single channel set. By receiving access commands via terminals associated with multiple channel sets, a memory device may support relatively faster operations (e.g., relative to a clock signal) by increasing a throughput of the access commands, which may enable the memory device to decode access commands and perform responsive operations in relatively fewer clock cycles. Decoding access commands in relatively fewer clock cycles may enable the memory device (e.g., in an evaluation mode, while coupled with an evaluation system) to execute responses to test commands relatively quickly (e.g., within threshold delays), which may support relatively high-performance memory devices being evaluated with relatively low-performance evaluation equipment (e.g., relatively low-speed evaluation equipment, evaluation equipment operating in accordance with relatively low-speed clock signals), among other benefits.

In addition to applicability in memory systems as described herein, interface techniques for multi-channel memory devices may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by allowing relatively lower-performance (e.g., lower speed) evaluation equipment, such as test equipment used to evaluate memory device manufacture, to be used for evaluating relatively higher-performance memory devices. Thus, a useful life of evaluation equipment may be extended, which may result in lowered production emissions and may extend the life of electronic devices, thereby reducing electronic waste, among other benefits.

Features of the disclosure are illustrated and described in the context of systems and architectures. Features of the disclosure are further illustrated and described in the context of block diagrams and flowcharts.

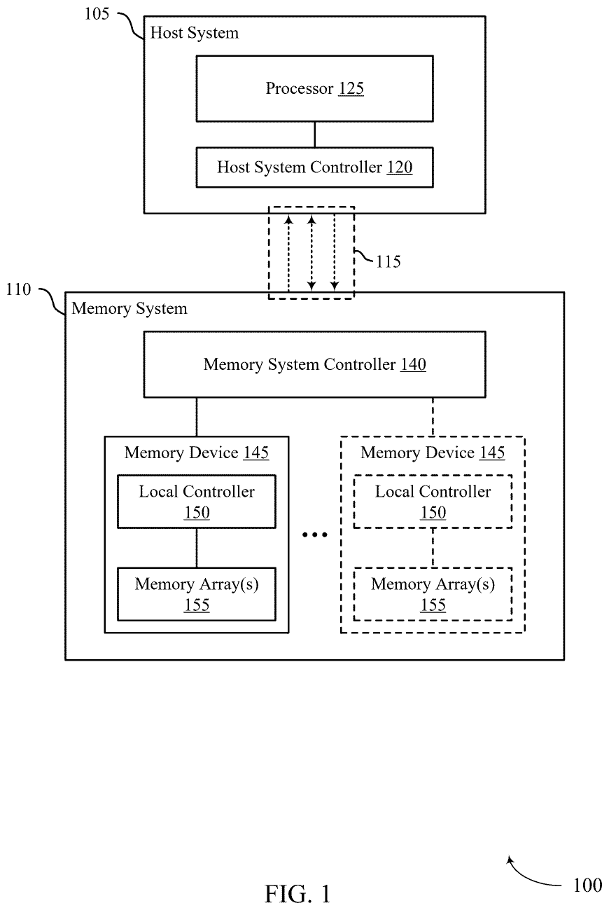

FIG. 1 illustrates an example of a system 100 that supports interface techniques for multi-channel memory devices in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

The host system 105 may include one or more components (e.g., circuitry, processing circuitry, one or more processing components) that use memory to execute processes, any one or more of which may be referred to as or be included in a processor 125. The processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. The processor 125 may be an example of a central processing unit (CPU), a graphics processing unit (GPU), a general-purpose GPU (GPGPU), or an SoC or a component thereof, among other examples.

The host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating the memory system 110, such as write commands, read commands, configuration signaling or other operational signaling. In some examples, the host system controller 120, or associated functions described herein, may be implemented by or be part of the processor 125. For example, a host system controller 120 may be hardware, instructions (e.g., software, firmware), or some combination thereof implemented by the processor 125 or other component of the host system 105. In various examples, a host system 105 or a host system controller 120 may be referred to as a host.

The memory system 110 provides physical memory locations (e.g., addresses) that may be used or referenced by the system 100. The memory system 110 may include a memory system controller 140 and one or more memory devices 145 (e.g., memory packages, memory dies, memory chips) operable to store data. The memory system 110 may be configurable for operations with different types of host systems 105, and may respond to commands from the host system 105 (e.g., from a host system controller 120). For example, the memory system 110 (e.g., a memory system controller 140) may receive a write command indicating that the memory system 110 is to store data received from the host system 105, or receive a read command indicating that the memory system 110 is to provide data stored in a memory device 145 to the host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of the memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with the host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 and one or more memory arrays 155. A memory array 155 may be a collection of memory cells (e.g., a two-dimensional array, a three-dimensional array), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FcRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system (e.g., a respective channel interface).

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

A command/address channel (e.g., a CA channel) may be operable to communicate commands between the host system 105 and the memory system 110, including control information associated with the commands (e.g., address information, configuration information). Commands carried by a command/address channel may include a write command with an address for data to be written to the memory system 110 or a read command with an address of data to be read from the memory system 110.

A clock signal channel may be operable to communicate one or more clock signals between the host system 105 and the memory system 110. Clock signals may oscillate between a high state and a low state, and may support coordination (e.g., in time) between operations of the host system 105 and the memory system 110. In some examples, a clock signal may provide a timing reference for operations of the memory system 110. A clock signal may be referred to as a control clock signal, a command clock signal, or a system clock signal. A system clock signal may be generated by a system clock, which may include one or more hardware components (e.g., oscillators, crystals, logic gates, transistors).

A data channel (e.g., a DQ channel) may be operable to communicate (e.g., bidirectionally) information (e.g., data, control information) between the host system 105 and the memory system 110. For example, a data channel may communicate information from the host system 105 to be written to the memory system 110, or information read from the memory system 110 to the host system 105. In some examples, channels 115 may include one or more error detection code (EDC) channels. An EDC channel may be operable to communicate error detection signals, such as checksums or parity bits, which may accompany information conveyed over a data channel.

In some implementations, channels 115 may be configured in accordance with one or more channel sets, each of the channel sets including one or more channels 115. One or more memory arrays 155, or portions of one or more memory arrays 155, may be associated with respective channel sets such that signaling (e.g., information, commands, data, clock signaling) associated with accessing the one or more memory arrays 155 may be communicated between the host system 105 and the memory system 110 via the corresponding channel set. In some examples, a channel set may include one or more command/address channels, one or more clock signal channels, and one or more data channels.

In some examples, a host system 105 and a memory system 110 (e.g., one or more memory devices 145) may be configured with multiple channel sets (e.g., sets of channels 115). Each channel set may include a command and address channel (e.g., a CA channel), a data channel (e.g., a DQ channel), and one or more clock channels (e.g., a WCK channel, an RCK channel, or a combination thereof) that support coordinated signaling between the memory device 145 and a host system 105. For example, the one or more clock channels may convey clock signals between the memory device 145 and the host system 105 (e.g., a clock signal from the host system 105 to the memory device 145, such as a WCK signal, a clock signal from the memory device 145 to the host system 105, such as an RCK signal). Each of the channel sets may be configured for communication of access commands and corresponding data (e.g., write data, read data), and may be associated with accessing a respective memory array 155. For example, a first channel set may support communication of access commands being performed on a first memory array 155, or portion thereof, and a second channel set may support communication of access commands being performed on a second memory array 155 or a different portion of the first memory array 155, among other implementations. In some cases (e.g., during device testing), it may be beneficial for a memory device 145 to operate relatively quickly (e.g., in accordance with fewer clock cycles, to evaluate relatively fast internal timings or delays) despite the memory device 145 being operated in accordance with relatively slow clock signaling (e.g., from a host system 105, from an evaluation system).

In accordance with examples described herein, a memory device 145 may also be configured to receive access commands via command and address terminals associated with both a first channel set and a second channel set (e.g., of a pair of channel sets) that may otherwise be received via command and address terminals associated with a single channel set. By receiving access commands via terminals associated with multiple channel sets, a memory device 145 may support relatively faster operations (e.g., relative to a clock signal) by increasing a throughput of the access command, which may enable the memory device 145 to decode access commands and perform responsive operations in relatively fewer clock cycles. Decoding access commands in relatively fewer clock cycles may enable the memory device 145 (e.g., in an evaluation mode, while coupled with an evaluation system) to execute responses to test commands relatively quickly (e.g., within threshold delays), which may support relatively high-performance memory devices 145 being evaluated with relatively low-performance evaluation equipment (e.g., relatively low-speed evaluation equipment, evaluation equipment operating in accordance with relatively low-speed clock signals), among other benefits.

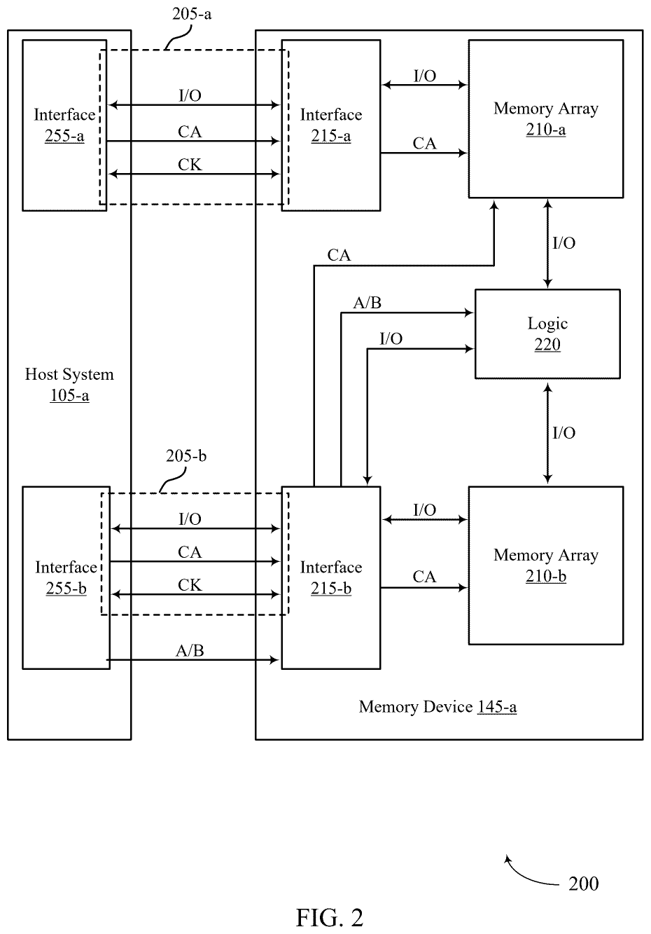

FIG. 2 shows an example of an architecture 200 that supports interface techniques for multi-channel memory devices in accordance with examples as disclosed herein. The architecture 200 may implement or may be implemented by aspects of a system 100. For example, the architecture 200 may include aspects of a memory device 145-a and a host system 105-a, which may be examples of corresponding devices described herein. The memory device 145-a may include a memory array 210-a and a memory array 210-b, which may each be an example of a memory array 155, or may be portions of a same memory array 155. The architecture 200 also includes channels 205 between the host system 105-a and the memory device 145-a (e.g., between a respective interface 255 and a respective interface 215), which may each be an example of a channel set of one or more channels 115. Although the architecture 200 illustrates two channels 205, aspects of the architecture 200 may be implemented with any quantity of two or more channels 205 (e.g., in accordance with integer multiples of channel pairs, with four channels 205).

In some examples, the channel 205-a and the channel 205-b may support communication between the host system 105-a and the memory device 145-a. Each of the channels 205 may include at least a CA bus and an I/O bus (e.g., a data bus, a DQ bus). In some examples, each channel 205 may also include a CK bus (e.g., a clock bus) associated with one or more clock channels (e.g., a WCK channel, an RCK channel, or both). Each of such buses may include any quantity of one or more signal paths. The channels 205 may be coupled with the memory device 145-a directly (e.g., without inclusion of or intervention of a memory system controller 140), or the channels 205 may be coupled with the memory device 145-a via a memory system controller 140 (not shown). For example, the channel 205-a and the channel 205-b may be coupled between a memory system controller 140 of a memory system 110 and the memory device 145-a.

In some examples, the channel 205-a may be coupled with terminals (e.g., pins, contacts, nodes) of an interface 215-a at the memory device 145-a and terminals of an interface 255-a at the host system 105-a (e.g., respective first channel interfaces), and the channel 205-b may be coupled with terminals of an interface 215-b at the memory device 145-a and terminals of an interface 255-b of the host system 105-a. The interfaces 215 and interfaces 255 may each include respective interface circuitry that is operable to support communications over at least a corresponding channel 205, such as transmitter circuitry (e.g., drivers) and receiver circuitry (e.g., latches), which may operate in accordance with clock signaling that is communicated using a same channel 205 or a different channel 205 (e.g., depending on a configured mode). In some examples, interfaces 215 may be portions of a local controller 150 of the memory device 145-a, and interfaces 255 may be portions of a host system controller 120 of the host system 105-a.

In some examples, the memory device 145-a may be configured (e.g., dynamically, by command, by manufacturing setting, by operation setting, by address) to operate in a two-channel mode (e.g., a channel-pair mode) or a one-channel mode. In some examples, configuration of the architecture 200 for the two-channel mode or the one-channel mode may be based on one or more bits of a mode register (e.g., as read during bootup, as read based on a reset command) or an indication from the host system 105-a (e.g., via a CA bus of the channel 205-a, the channel 205-b, or both). The memory device 145-a may be configured to operate in any integer multiples of the two-channel mode and the one-channel mode, including such modes that may be based on a quantity of memory dies of the memory device 145-a. For example, the memory device 145-a may include two semiconductor dies, the two dies each configurable in one of the one-channel mode or the two-channel mode. In such examples, the memory device 145-a may be configured to operate in a four-channel mode (e.g., with both dies configured in a two-channel mode) or a two-channel mode (e.g., with both dies configured in the one-channel mode), or with one die configured in a one-channel mode and the other die configured in a two-channel mode, among other examples.

In an example of a two-channel mode, the memory device 145-a may be configured to access (e.g., store, read) first data communicated via the channel 205-a (e.g., via the interface 215-a) in the memory array 210-a and may access second data communicated via the channel 205-b (e.g., via the interface 215-b) in the memory array 210-b. For example, the host system 105-a may transmit a first write command to the memory device 145-a via the CA bus of the channel 205-a, with first data associated with the first write command transmitted via the I/O bus of the channel 205-a, and the memory device 145-a may store the first data at an address of the memory array 210-a based on the first write command. The host system 105-a may transmit a second write command to the memory device 145-a via the CA bus of the channel 205-b, with second data associated with the second write command via the I/O bus of the channel 205-b, and the memory device 145-a may store the second data at an address of the memory array 210-b based on the second write command. In the two-channel mode, the interface 215-i a may thus be associated with the memory array 210-a (e.g., without being associated with the memory array 210-a) and the interface 215-b may be associated with the memory array 210-b (e.g., without being associated with the memory array 210-a). Accordingly, the two-channel mode may be associated with the channel 205-a and the channel 205-b such that both the channel 205-a and the channel 205-b may support communication between the memory device 145-a and the host system 105-a (e.g., for accessing respective memory arrays 210, for concurrent access, for parallel access). In other words, the two-channel mode may utilize two channel sets, and each channel set may correspond to (e.g., may support access of) address space of a respective memory array 210.

In an example of a one-channel mode, the memory device 145-a may be configured to access data communicated via the channel 205-b (e.g., via the interface 215-b, without operating the interface 215-a, while the interface 215-a is disabled) in either the memory array 210-a or the memory array 210-b based on an address indication associated with access commands, which may, in some examples, be conveyed separately from a CA bus of the channel 205-b (e.g., via an A/B bus, which may be associated with the channel 205-b or shared between the channels 205-a and 205-a ). For example, the host system 105-145-a may transmit a write command to the memory device 145-a via the CA bus of the channel 205-b and may indicate, via the A/B bus, whether the data associated with the write command is to be stored in the memory array 210-a or the memory array 210-b . The memory device 145-a may store the data in the memory array 210-a or the memory array 210-b based on the indication (e.g., A/B indication) from the host system 105-a. Accordingly, the one-channel mode may be associated with the channel 205-b (e.g., and not the channel 205-a) such that the channel 205-b may support communication between the memory device 145-a and the host system 105-a (e.g., for accessing multiple memory arrays 210), while the channel 205-a may be unused or used for different access operations or configurations. In other words, the one-channel mode may utilize a single channel set, and the channel set may correspond to (e.g., may support access of) address space of multiple memory arrays 210.

In the one-channel mode, the memory device 145-a may store data communicated via the channel 205-b in one of the memory array 210-a or the memory array 210-b based on an A/B bus (e.g., an address indication) of the data. For example, the host system 105-a may transmit a write command to the memory device 145-a via the CA bus of the channel 205-b and may indicate, via the A/B bus, whether the data associated with the write command is to be stored in the memory array 210-a or the memory array 210-b. The memory device 145-a may store the data in the memory array 210-a or the memory array 210-b based on the indication (e.g., A/B indication) from the host. In some examples, the A/B bus may be separate from the channel 205-b. In other examples, the A/B bus may be included in one or more channel sets (e.g., the channel 205-b). The one-channel mode may be associated with the channel 205-b such that the channel 205-b supports communication between the memory device 145-a and the host system 105-a while the channel 205-a is unused. In other words, the one-channel mode may utilize a single channel set, and the channel set may correspond to (e.g., may support access of) two or more memory arrays 210.

In some implementations, the memory device 145-a may include logic 220 (e.g., arbitration logic), which also may be a portion of a local controller 150. The logic 220 may receive the indication from the A/B bus as input and may determine whether an access command communicated via the channel 205-b is directed to accessing the memory array 210-a or the memory array 210-b. The logic 220 may, in the case of a read command, return data from one of the memory array 210-a or the memory array 210-b based on the memory array 210 that is indicated by the A/B indication. In the case of a write command, the logic 220 may send data received from the host system 105-a (e.g., via the channel 205-b) to one of the memory array 210-a or the memory array 210-b based on the A/B indication.

The memory arrays 210-a and 210-b may be implemented in various ways to support configurations in a one-channel mode, a two-channel mode, or both. For example, the memory array 210-a may be associated with a first physical location in the memory device 145-a and may be segmented from the memory array 210-b, which may be associated with a second physical location in the memory device 145-a. In some examples, separation (e.g., logical separation) between the memory array 210-a and the memory array 210-b may be based on a dynamic allocation (e.g., a selection) of one or more portions of a memory array 155 to establish operation as a memory array 210-a and a memory array 210-b. Such dynamic allocation of memory arrays 210 may be based on one or more operations of the memory device 145-a, one or more commands received from the host system 105-a, or both.

In some examples (e.g., in a two-channel mode), the channel 205-a may support communication of first access commands being performed on a memory array 210-a and the channel 205-b may support communication of second access commands, different from the first access commands, being performed on a memory array 210-b. In some cases (e.g., during evaluation of operations of the memory device 145-a), it may be beneficial for the memory device 145-a to operate relatively quickly (e.g., in accordance with fewer clock cycles of clock signaling conveyed over one or more channels 205, to evaluate relatively fast internal timings or delays) despite the memory device 145-a being operated in accordance with relatively slow clock signaling (e.g., from the host system 105-a, from an evaluation system).

In accordance with examples described herein, the memory device 145-a may (e.g., in addition to the two-channel mode, the one-channel mode, or both) be configured to receive access commands via CA pins of both the channel 205-a and the channel 205-b (e.g., a pair of channels 205, via terminals of both the interface 215-a and the interface 215-b) that would otherwise be received via CA pins of a single channel 205 (e.g., the channel 205-a). By receiving access commands via the CA pins of the pair of channels 205, the memory device 145-a may support relatively faster operations (e.g., relative to CK signaling from the host system 105-a, such as WCK signaling) by increasing a throughput of the access commands, which may enable the memory device 145-a to decode access commands and perform responsive operations in relatively fewer clock cycles. Decoding access commands in relatively fewer clock cycles may enable the memory device 145-a (e.g., in a testing environment with the host system 105-a) to execute responses to test commands within threshold delays, which may support relatively high-performance memory devices being evaluated with relatively low-performance evaluation equipment (e.g., relatively low-speed evaluation equipment, evaluation equipment operating in accordance with relatively low-speed clock signals), among other benefits.

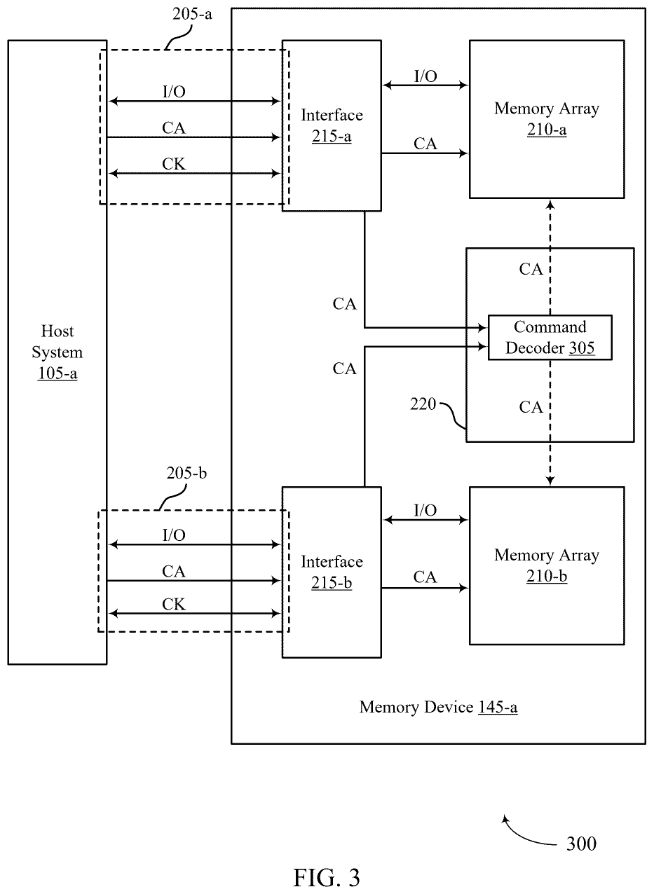

FIG. 3 shows an example of an architecture 300 that supports interface techniques for multi-channel memory devices in accordance with examples as disclosed herein. The architecture 300 may implement or may be implemented by aspects of a system 100. For example, the architecture 300 may include a memory device 145-a and a host system 105-a, which may be examples of corresponding devices described herein (e.g., as described with reference to FIG. 2). The architecture 300 may illustrate aspects of configurations of the memory device 145-a and host system 105-a to support an evaluation mode (e.g., a test interface mode), which may be supported by the host system 105-a, the memory device 145-a, or both in addition to the one-channel mode, the two-channel mode, or both in accordance with the architecture 200.

In the two-channel mode, the memory device 145-a may be configured to receive access commands via the CA bus of channel 205-a to access memory stored in the memory array 210-a, and to receive access commands via the CA bus of the channel 205-b to access memory stored in the memory array 210-b. In some examples, a speed of decoding the access commands, and responsive operations, may be based on a speed of a clock signal at the memory device 145-a. Clock signals used for decoding and responsive operations may include or be based on a clock signal that is received from the host system 105-a (e.g., a write clock (WCK)) via a clock terminal of the channel 205-a (e.g., of the interface 215-a) or via a clock terminal of the channel 205-b (e.g., of the interface 215-b), or both. In some examples, evaluations of internal operations (e.g., delays, response times) of the memory device 145-a may involve relatively fast clock signaling and processing times of evaluation equipment (e.g., an example of a host system 105-a). However, evaluation equipment that supports such fast clock signaling and processing times may be relatively expensive, and may not be transferrable from evaluations of relatively lower-performance memory devices 145.

In accordance with examples described herein, the memory device 145-a may be configured to operate in another mode (e.g., an evaluation mode, different than the two-channel mode and the one channel mode described with reference to architecture 200) for implementing command/address decoding and responsive operations, which may support decoding signaling over combinations of multiple channels 205, different types and responses to clock signaling, or a combination thereof. In the evaluation mode, the memory device 145-a may decode access commands communicated via the CA terminals of both the channel 205-a and the channel 205-b (e.g., five CA terminals in each channel 205, ten CA terminals in total). For example, the interface 215-a may receive, via the channel 205-a, a first subset of bits of an access command and the interface 215-b may receive, via the channel 205-b, a second subset of bits of the same access command. The memory device 145-a may decode the access command by providing the first subset of bits and the second subset of bits to a command decoder 305 (e.g., of shared logic 220). The command decoder 305 may determine a type of the access command (e.g., a column command, a row command, an activation command, a read command, a write command, a precharge command, a refresh command) and an address of a memory array 210 (e.g., one of the memory array 210-a or the memory array 210-b) for the command based on a combined decoding the first subset of bits and the second subset of bits of the access command. By utilizing the CA terminals of both the channel 205-a and the channel 205-b for decoding the access command, the memory device 145-a may decode twice as many command bits (e.g., per clock cycle, per latching instance) which may enable the memory device 145-a to decode access commands at a faster rate (e.g., increased by a factor of two), or at a higher throughput, or both relative to the two-channel mode.

In some examples, the memory device 145-a may receive an indication (e.g., from the host system 105-a) that configures the memory device 145-a in the two-channel testing interface mode. For example, the memory device 145-a may receive an indication of an evaluation condition of the memory device 145-a that indicates that the memory device 145-a is in a testing mode. In some examples, the indication may be based on an absence of connection at a terminal of the memory device 145-a (e.g., an absence of a termination resistance being coupled with an impedance terminal of the memory device 145-a, such as an absence of a termination of a ZQ terminal, during a ZQ calibration, a power-up of the memory device 145-a, an initialization sequence), evaluation signaling (e.g., via one or more terminals of a channel 205), a combination of values indicated via the CA terminals of one or more of the channels 205, or a combination thereof.

In some examples, the memory array 210-a may be a portion of a memory array 155. The memory device 145-a may be configured to operate the portion of the memory array 155 that includes the memory array 210-a in the evaluation mode and to operate another portion of the memory array 155 in a one-channel mode, a two-channel mode, or both. In an example, the portion of the memory array 155 configured to operate in the evaluation mode may be associated with testing a memory core of the memory device 145-a and another portion of the memory array 155 configured to operate in the two-channel mode or the one-channel mode may be associated with testing of I/O toggling. In some examples, an indication from the host system 105-a (e.g., via evaluation signaling, absence of connection at the ZQ terminal, combinations of values via the CA terminals) may indicate, to the memory device 145-a, a first portion of the memory array 155 (e.g., a percentage, a quantity of memory cells, a set of addresses) that is to be configured in the evaluation mode, a second portion of the memory array 155 that is to be configured in the two-channel mode or the one-channel mode (e.g., as described with reference to architecture 200), or both.

In some examples, the memory device 145-a may receive a first clock signal (e.g., a first WCK signal) via a clock terminal of the channel 205-a (e.g., via interface 215-a) and a second clock signal (e.g., a second WCK signal) via a clock terminal of the channel 205-b (e.g., via interface 215-b). In some cases (e.g., in accordance with a one-channel mode or a two-channel mode described with reference to the architecture 200, in accordance with an installed implementation of the memory device 145-a), to decode access commands of the channel 205-a, the memory device 145-a may latch signals on the CA terminals of the channel 205-a in alignment with (e.g., upon, in response to) rising edges of the first clock signal and, to decode access commands of the channel 205-b, may latch CA terminals of the channel 205-b in alignment with rising edges of the second clock signal. In some other cases (e.g., in accordance with the evaluation mode), to decode access commands, the memory device 145-a may latch CA terminals of both the channel 205-a and the channel 205-b in alignment with rising and falling edges of a clock signal, which, in various examples, may be the first clock signal received via the channel 205-a or the second clock signal received via the channel 205-b. By latching the CA terminals of two channels 205, and in accordance with rising and falling edges of the first or second clock signal, the evaluation mode may support faster decoding of access commands and performance of responsive operations (e.g., relative to quantities of clock cycles) compared with other modes, which may support evaluations of relatively fast operations (e.g., bank activations, row activations, precharge delays, which may be related to tRP timing, row-to-column delays, which may be related to tRCD timing) internal to the memory device 145-a despite being operated in accordance with a relatively slower clock signal (e.g., of a relatively lower performance host system 105-a, such as a relatively slower tester).

In an illustrative example, the CA bus of each of the channel 205-a and the channel 205-b may be associated with a configured quantity of CA terminals (e.g., five terminals, of a respective interface 215, of a respective interface 255). The memory device 145-a may, in some modes, receive multiple bits of an access command via the CA bus of a single channel 205 over multiple latching events, such as multiple clock cycles (e.g., multiple rising edges), and the memory device 145-a (e.g., a local controller 150) may combine (e.g., serially) the multiple bits as part of decoding the access command. In some examples, an access command may include a set (e.g., a collection, a group) of commands including row commands and column commands. The memory device 145-a may be configured to receive row commands via a first subset (e.g., three terminals) of the CA terminals and receive column commands via a second subset (e.g., two terminals) of the CA terminals. In some examples, the memory device 145-a may be configured to receive interleaved row commands and column commands. By interleaving the row and column commands, the memory device 145-a may receive bits of the row commands from the host system 105-a, via the first subset of the CA terminals, and bits of the column commands from the host system 105-a, via the second subset of the CA terminals, concurrently (e.g., in at least partially-overlapping latching events). Accordingly, group common circuitry at the memory device 145-a (e.g., of a local controller 150, of an interface 215, of a command decoder 305) may decode a first half of a command (e.g., a row command, an activation command) concurrently with a second half of a command (e.g., a column command, a read command).

A first example of a row command may be an activate command, which may select a memory array 210 (e.g., a memory array 210-a) and may indicate to activate (e.g., select) a row of the memory array 210. A second example of a row command may be a precharge command, which may indicate to deactivate a row (e.g., previously activated row) of a memory array 210 (e.g., a memory bank). An example of a column command may be a read command, which may select a memory array 210 (e.g., the memory array 210-a), activate (e.g., select) a column of the memory array 210, and initiate a burst of data (e.g., at the activated row and activated column), which may be communicated via a DQ bus of one or more channels 205. A duration between deactivation of a first row of the memory array 210 and activation of a second row of the memory array 210 may be referred to as a row precharge time (tRP). A duration between activation of a row of the memory array 210 and activation of a column of the memory array 210 may be referred to as a row address strobe (RAS) to column address strobe (CAS) delay time (tRCD).

In some examples (e.g., in accordance with the two-channel mode), the memory device 145-a may receive bits of an access command via a channel 205-a (e.g., at an interface 215-a). Group common circuitry (e.g., of a local controller 150) of the memory device 145-a, which may be included in the logic 220, may decode bits of the access command and generate internal signals associated with row commands (e.g., row operations), column commands (e.g., column operations), or both. For example, the interface 215-a may receive bits of the access command associated with row commands via the first subset of CA terminals, and the group common circuitry may generate (e.g., based on a decoding) an internal bank select (BankSel) signal indicating which memory array 210 to deactivate, which memory array 210 to activate, or both. The interface 215-a may receive bits of the access command associated with column commands via the second subset of CA terminals, and the group common circuitry may generate (e.g., based on a decoding) an internal read signal that indicates a memory cell of the activated memory array 210 from which to read data.

In some other examples (e.g., in accordance with the evaluation mode), the memory device 145-a may receive first bits of an access command via a channel 205-a (e.g., at an interface 215-a) and second bits of the access command via a channel 205-b (e.g., at an interface 215-b), and the group common circuitry of the memory device 145-a (e.g., the logic 220, the command decoder 305) may decode the bits of the access command received via both channels to generate the internal signals (e.g., bank select, read).

In some examples, a first tRP delay (e.g., equal to two clock cycles of WCK signaling) associated with the evaluation mode of the memory device 145-a may correspond to fewer clock cycles than a second tRP (e.g., equal to eight clock cycles of WCK signaling) associated with the two-channel mode of the memory device 145-a. Similarly, a first tRCD (e.g., equal to one clock cycle of WCK signaling) associated with the evaluation mode of the memory device 145-a may correspond to fewer clock cycles than a second tRCD (e.g., four clock cycles of WCK signaling) associated with the two-channel mode of the memory device 145-a. That is, the evaluation mode may enable an increase in decoding speed (e.g., relative to clock cycles) by a total factor of four through a combination of parallelizing CA pins of the channel 205-a and the channel 205-b and latching the CA pins at rising and falling edges of the corresponding clock signaling (e.g., WCK signaling). In some examples, a combined delay value that combines at least the tRP delay and the tRCD delay may correspond to a delay between a read command (e.g., reception of a read command at the memory device 145-a via the CA bus of a channel 205) and responsive data (e.g., an output of data to the host via a data bus of a channel 205). A first duration between a read command and responsive data based on performing the read command in the two-channel testing interface mode may be less than (e.g., may be associated with fewer clock cycles than) a second duration between a read command and responsive data based on performing the read command in the two-channel mode.

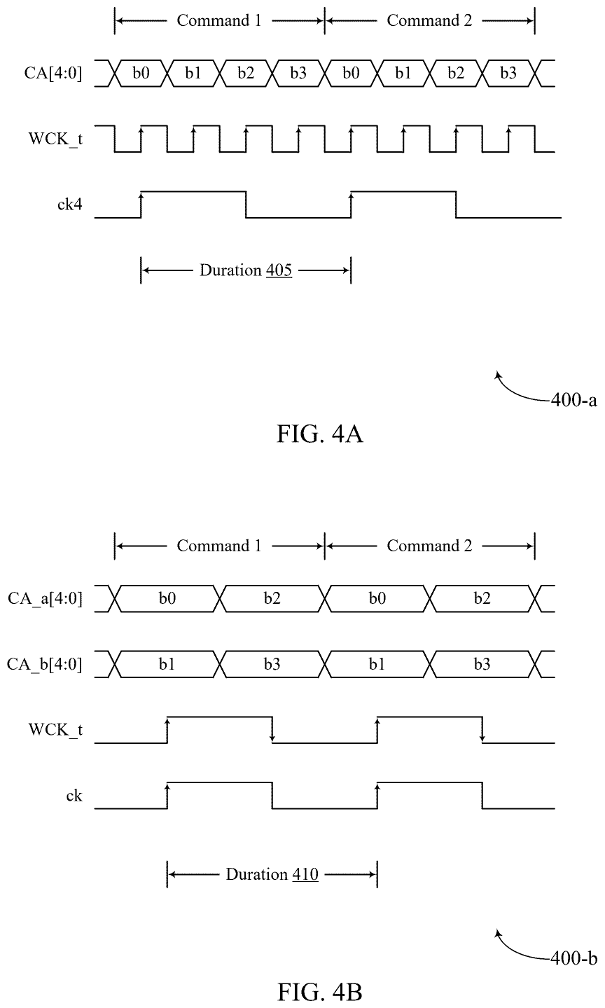

FIGS. 4A and 4B illustrate signaling schemes 400-a and 400-b that support interface techniques for multi-channel memory devices in accordance with examples as disclosed herein. In some examples, the signaling scheme 400-a may be implemented in a two-channel mode or a one-channel mode (e.g., in accordance with the architecture 200), and the signaling scheme 400-a may be implemented in an evaluation mode (e.g., in accordance with the architecture 300).

Each of the signaling schemes 400-a and 400-b illustrate signaling via command/address terminals (e.g., CA terminals) and clock terminals (e.g., WCK terminals, terminals for receiving a clock signal from a host system 105) of channels 205. For example, each of such channels 205 may include five CA terminals and a single WCK_t terminal, but may be accompanied by other terminals (e.g., a complementary WCK_c terminal for a clock signal having an opposite phase from WCK_t, DQ terminals, and other terminals). In each of the signaling schemes 400-a and 400-b, commands are illustrated in accordance with four bit positions (e.g., b0-b4, which may refer to latching occasions on each of the CA terminals), such that each illustrated command includes 20 bits of CA signaling. However, commands in accordance with the described techniques may include any quantity of bits, which may vary by command type (e.g., between row commands and column commands, among other distinctions).

In the example of signaling scheme 400-a, CA signals of a channel 205 may be latched in alignment with rising edges of the WCK_t signal of the same channel 205 and subsequently decoded. Accordingly, the illustrated commands, and latching and decoding thereof, may each be associated with four clock cycles of the WCK_t signal. Internal operations of a memory device 145 may be performed using a ck4 clock signal, which may be generated internal to the memory device 145 based on a division (e.g., a frequency division) of the WCK_t signal when configured in the one-channel or two-channel modes. In the example of signaling scheme 400-a, the ck4 signal may have a frequency that is one fourth the frequency of the WCK_t signal. Operational durations (e.g., decoding durations, durations to perform operations in response to a command) and delays (e.g., delays between a command and an operation, delays between a first command and a second command, delays between a first operation and a second operation) may be measured relative to or in accordance with a duration 405, which may correspond to a cycle of the ck4 clock. In some examples, timing such as tRP or tRCD timing may be evaluated relative to an integer quantity of the duration 405, or related interval. For example, tRP may be configured to be within two durations 405 (e.g., two cycles of the ck4 signal, eight cycles of the WCK_t signal, relative to an initiating command or operation), and tRCD may be configured to be within one duration 405 (e.g., one cycle of the ck4 signal, four cycles of the WCK_t signal, relative to an initiating command or operation). However, such techniques that are performed on a relatively high-performance memory device 145 may involve relatively high-performance evaluation equipment that can operate in accordance with relatively high-frequency CA and WCK signaling.

In the example of signaling scheme 400-b, CA signals of two channels 205 (e.g., CA_a and CA_b signals) may be combined for communicating command and address signaling. The CA signals of the two channels 205 may be latched in alignment with rising edges and falling of a WCK_t signal (e.g., triggered based on rising edges of a WCK_t signal and rising edges of a WCK_c signal, not shown, among other implementations), which may be received via either of the channels 205, and subsequently decoded. Accordingly, the illustrated commands, and latching and decoding thereof, may each be associated with one clock cycle of the WCK_t signal. Internal operations of a memory device 145 may be performed using a ck clock signal, which may omit a division (e.g., may have the same frequency as the WCK_t signal) when configured in the evaluation mode. Operational durations (e.g., decoding durations, durations to perform operations in response to a command) and delays (e.g., delays between a command and an operation, delays between a first command and a second command, delays between a first operation and a second operation) may be measured relative to or in accordance with a duration 410, which may correspond to a cycle of the ck clock, and may have a same or similar duration as the duration 405. Thus, timing such as tRP or tRCD timing may be evaluated relative to an integer quantity of the duration 410, which may be relevant to (e.g., representative of) such evaluations performed relative to the duration 405. For example, tRP may be evaluated for being within two durations 410 (e.g., two cycles of the ck signal, two cycles of the WCK_t signal), and tRCD may be evaluated for being within one duration 410 (e.g., one cycle of the ck signal, one cycle of the WCK_t signal). Accordingly, the signaling scheme 400-b may be implemented (e.g., configurable at a memory device 145) to evaluate relatively fast operations of a relatively high-performance memory device 145, while using relatively lower-performance evaluation equipment that is operating in accordance with relatively lower-frequency CA and WCK signaling (e.g., at one quarter of the WCK frequency illustrated in the example of signaling scheme 400-a).

Thus, in accordance with these and other examples (e.g., in accordance with an architecture 200, an architecture 300, or a combination thereof), a memory system 110 (e.g., one or more memory devices 145) may be configured with multiple channels 205 that can be operated in different modes, including an evaluation interface. For example, the memory device 145-a may be configured for operations in a first mode (e.g., a two-channel mode, a one-channel mode, in accordance with the architecture 200) in which the memory device 145 decodes first access commands communicated using one or more first CA terminals of a first channel 205 and decodes second access commands communicated using one or more second CA terminals of a second channel 205. In some examples, the memory device 145 may use a divided clock signal for internal operations in accordance with the first mode. The memory device 145 may also be configured for operations in a second mode (e.g., an evaluation mode) in which the memory device 145 decodes third access commands communicated using the one or more first CA terminals of the first channel 205 and the second channel 205-b. The second mode may enable the memory device 145 to perform testing operations at a relatively high speed despite using a relatively slow clock (e.g., a low speed testing interface).

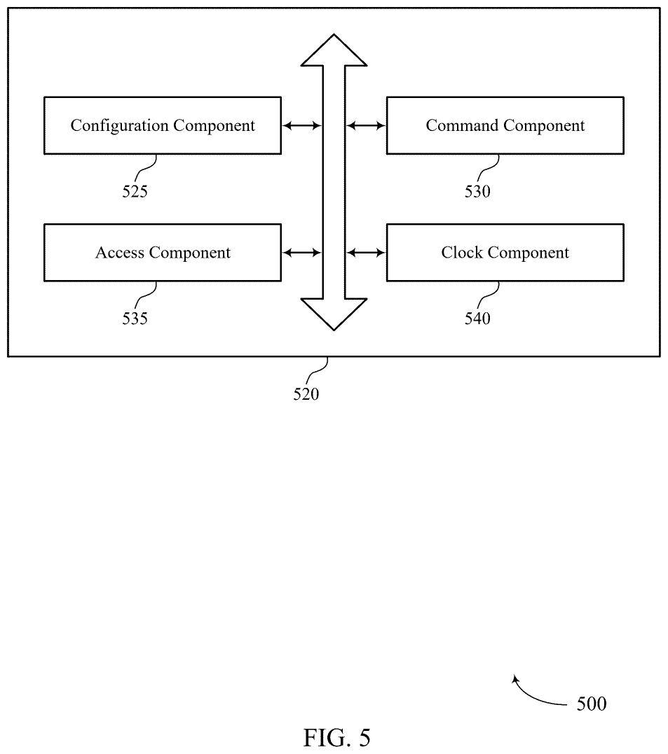

FIG. 5 shows a block diagram 500 of a memory system 520 that supports interface techniques for multi-channel memory devices in accordance with examples as disclosed herein. The memory system 520 may be an example of aspects of a memory system (e.g., a memory system 110, a memory device 145) as described with reference to FIGS. 1 through 3. The memory system 520, or various components thereof, may be an example of means for performing various aspects of interface techniques for multi-channel memory devices as described herein. For example, the memory system 520 may include a configuration component 525, a command component 530, an access component 535, a clock component 540, or any combination thereof. Each of these components, or components of subcomponents thereof (e.g., one or more processors, one or more memories), may communicate, directly or indirectly, with one another (e.g., via one or more buses).

The configuration component 525 may be configured as or otherwise support a means for configuring a memory device, having a plurality of memory arrays, a first channel interface, and a second channel interface, for operations in a first mode in which the memory device decodes access commands communicated using one or more first command/address terminals of the first channel interface and one or more second command/address terminals of the second channel interface. The command component 530 may be configured as or otherwise support a means for receiving, based at least in part on configuring the memory device for the operations in the first mode, a first set of bits of an access command via the one or more first command/address terminals of the first channel interface and a second set of bits of the access command via the one or more second command/address terminals of the second channel interface. The access component 535 may be configured as or otherwise support a means for performing, based at least in part on receiving the first set of bits via the one or more first command/address terminals of the first channel interface and receiving the second set of bits via the one or more second command/address terminals of the second channel interface, an access operation on a memory array of the plurality of memory arrays.

In some examples, to support configuring the memory device for the operations in the first mode, the clock component 540 may be configured as or otherwise support a means for configuring the memory device to decode access commands in the first mode based at least in part on a first clock signal received via a first clock terminal of the first channel interface or a second clock signal received via a second clock terminal of the second channel interface.

In some examples, the configuration component 525 may be configured as or otherwise support a means for configuring the memory device for second operations in a second mode in which the memory device decodes second access commands communicated using the one or more first command/address terminals of the first channel interface. In some examples, the command component 530 may be configured as or otherwise support a means for receiving, based at least in part on configuring the memory device for the second operations in the second mode, a third set of bits of a second access command via the one or more first command/address terminals of the first channel interface. In some examples, the access component 535 may be configured as or otherwise support a means for performing, based at least in part on receiving the third set of bits via the one or more first command/address terminals of the first channel interface, a second access operation on a memory array of the plurality of memory arrays.

In some examples, to support configuring the memory device for the second operations in the second mode, the clock component 540 may be configured as or otherwise support a means for configuring the memory device to decode second access commands in the second mode based at least in part on a first clock signal received via a first clock terminal of the first channel interface.

In some examples, to support configuring the memory device for the second operations in the second mode, the clock component 540 may be configured as or otherwise support a means for configuring the memory device to decode the second access commands in the second mode based at least in part on latching of the first command/address terminals that is aligned with rising edges of the first clock signal.

In some examples, configuring the memory device for the operations in the first mode is based at least in part on an indication of an evaluation condition of the memory device.

In some examples, configuring the memory device for the operations in the first mode is based at least in part on an indication via the one or more first command/address terminals, the one or more second command/address terminals, or a combination thereof.

In some examples, the first channel interface includes the one or more first command/address terminals, one or more first clock terminals associated with the one or more first command/address terminals, and one or more first data terminals associated with the one or more first command/address terminals. In some examples, the second channel interface includes the one or more second command/address terminals, one or more second clock terminals associated with the one or more second command/address terminals, and one or more second data terminals associated with the one or more second command/address terminals.

In some examples, to support configuring the memory device for the operations in the first mode, the clock component 540 may be configured as or otherwise support a means for configuring the memory device to decode the access commands in the first mode based at least in part on latching of the first command/address terminals and the second command/address terminals that is aligned with rising edges and falling edges of the first clock signal or the second clock signal.

In some examples, the described functionality of the memory system 520 (e.g., a memory system 110, a memory device 145), or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 520, or various components thereof, may be implemented at least in part by instructions (e.g., stored in memory, non-transitory computer-readable medium) executable by such at least one processor.

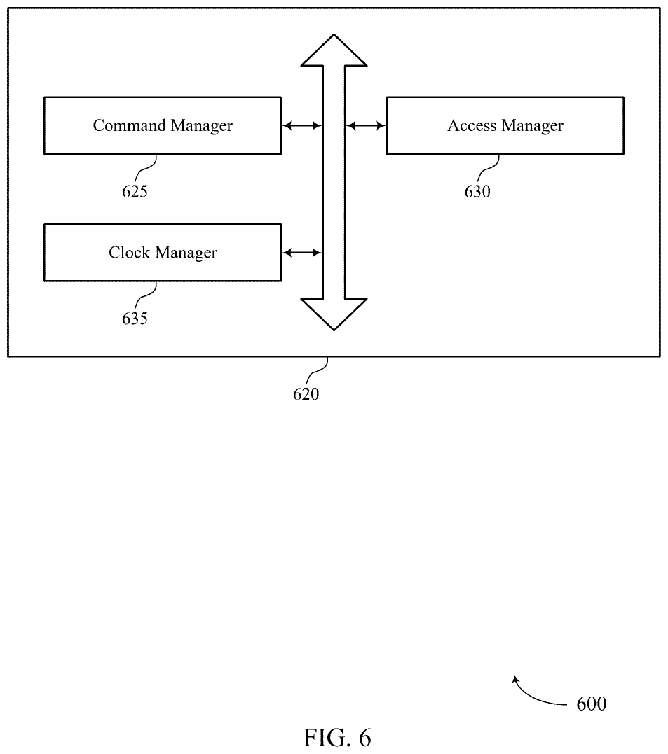

FIG. 6 shows a block diagram 600 of a host system 620 that supports interface techniques for multi-channel memory devices in accordance with examples as disclosed herein. The host system 620 may be an example of aspects of a host system (e.g., a host system 105) as described with reference to FIGS. 1 through 3. The host system 620, or various components thereof, may be an example of means for performing various aspects of interface techniques for multi-channel memory devices as described herein. For example, the host system 620 may include a command manager 625, an access manager 630, a clock manager 635, or any combination thereof. Each of these components, or components of subcomponents thereof (e.g., one or more processors, one or more memories), may communicate, directly or indirectly, with one another (e.g., via one or more buses).

The command manager 625 may be configured as or otherwise support a means for transmitting, from a host device having a first channel interface and a second channel interface, a first set of bits of an access command via the one or more first command/address terminals of the first channel interface and a second set of bits of the access command via the one or more second command/address terminals of the second channel interface. The access manager 630 may be configured as or otherwise support a means for receiving, based at least in part on transmitting the first set of bits via the one or more first command/address terminals of the first channel interface and the second set of bits via the one or more second command/address terminals of the second channel interface, a response to the access command.

In some examples, the command manager 625 may be configured as or otherwise support a means for transmitting, from the host device, a third set of bits of a second access command via the one or more first command/address terminals of the first channel interface. In some examples, the access manager 630 may be configured as or otherwise support a means for receiving, based at least in part on transmitting the third set of bits via the one or more first command/address terminals of the first channel interface, a second response to the second access command.

In some examples, the first set of bits and the second set of bits are transmitted in accordance with rising edges and falling edges of a clock signal conveyed via a clock terminal of the first channel interface. In some examples, the third set of bits are transmitted in accordance with rising edges of the clock signal conveyed via the clock terminal of the first channel interface.

In some examples, the first channel interface includes the one or more first command/address terminals, one or more first clock terminals associated with the one or more first command/address terminals, and one or more first data terminals associated with the one or more first command/address terminals, and the second channel interface includes the one or more second command/address terminals, one or more second clock terminals associated with the one or more second command/address terminals, and one or more second data terminals associated with the one or more second command/address terminals.

In some examples, the described functionality of the host system 620, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the host system 620, or various components thereof, may be implemented at least in part by instructions (e.g., stored in memory, non-transitory computer-readable medium) executable by such at least one processor.

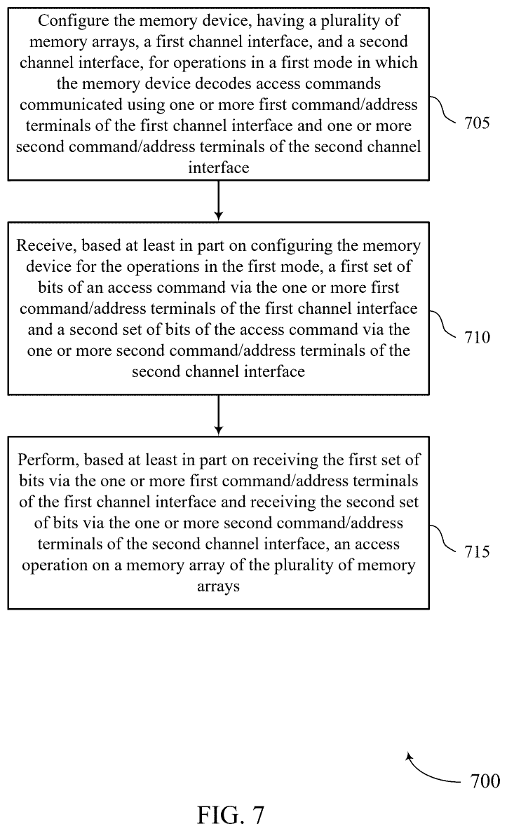

FIG. 7 shows a flowchart illustrating a method 700 that supports interface techniques for multi-channel memory devices in accordance with examples as disclosed herein. The operations of method 700 may be implemented by a memory system (e.g., a memory device) or its components as described herein. For example, the operations of method 700 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 705, the method may include configuring a memory device, having a plurality of memory arrays, a first channel interface, and a second channel interface, for operations in a first mode in which the memory device decodes access commands communicated using one or more first command/address terminals of the first channel interface and one or more second command/address terminals of the second channel interface. In some examples, aspects of the operations of 705 may be performed by a configuration component 525 as described with reference to FIG. 5.

At 710, the method may include receiving, based at least in part on configuring the memory device for the operations in the first mode, a first set of bits of an access command via the one or more first command/address terminals of the first channel interface and a second set of bits of the access command via the one or more second command/address terminals of the second channel interface. In some examples, aspects of the operations of 710 may be performed by a command component 530 as described with reference to FIG. 5.

At 715, the method may include performing, based at least in part on receiving the first set of bits via the one or more first command/address terminals of the first channel interface and receiving the second set of bits via the one or more second command/address terminals of the second channel interface, an access operation on a memory array of the plurality of memory arrays. In some examples, aspects of the operations of 715 may be performed by an access component 535 as described with reference to FIG. 5.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for configuring the memory device, having a plurality of memory arrays, a first channel interface, and a second channel interface, for operations in a first mode in which the memory device decodes access commands communicated using one or more first command/address terminals of the first channel interface and one or more second command/address terminals of the second channel interface; receiving, based at least in part on configuring the memory device for the operations in the first mode, a first set of bits of an access command via the one or more first command/address terminals of the first channel interface and a second set of bits of the access command via the one or more second command/address terminals of the second channel interface; and performing, based at least in part on receiving the first set of bits via the one or more first command/address terminals of the first channel interface and receiving the second set of bits via the one or more second command/address terminals of the second channel interface, an access operation on a memory array of the plurality of memory arrays.

Aspect 2: The method, apparatus, or non-transitory computer-readable medium of aspect 1, where configuring the memory device for the operations in the first mode includes operations, features, circuitry, logic, means, or instructions, or any combination thereof for configuring the memory device to decode access commands in the first mode based at least in part on a first clock signal received via a first clock terminal of the first channel interface or a second clock signal received via a second clock terminal of the second channel interface.

Aspect 3: The method, apparatus, or non-transitory computer-readable medium of any of aspects 1 through 2, further including operations, features, circuitry, logic, means, or instructions, or any combination thereof for configuring the memory device for second operations in a second mode in which the memory device decodes second access commands communicated using the one or more first command/address terminals of the first channel interface; receiving, based at least in part on configuring the memory device for the second operations in the second mode, a third set of bits of a second access command via the one or more first command/address terminals of the first channel interface; and performing, based at least in part on receiving the third set of bits via the one or more first command/address terminals of the first channel interface, a second access operation on a memory array of the plurality of memory arrays.

Aspect 4: The method, apparatus, or non-transitory computer-readable medium of aspect 3, where configuring the memory device for the second operations in the second mode includes operations, features, circuitry, logic, means, or instructions, or any combination thereof for configuring the memory device to decode second access commands in the second mode based at least in part on a first clock signal received via a first clock terminal of the first channel interface.

Aspect 5: The method, apparatus, or non-transitory computer-readable medium of aspect 4, where configuring the memory device for the second operations in the second mode includes operations, features, circuitry, logic, means, or instructions, or any combination thereof for configuring the memory device to decode the second access commands in the second mode based at least in part on latching of the first command/address terminals that is aligned with rising edges of the first clock signal.

Aspect 6: The method, apparatus, or non-transitory computer-readable medium of any of aspects 1 through 5, where configuring the memory device for the operations in the first mode is based at least in part on an indication of an evaluation condition of the memory device.

Aspect 7: The method, apparatus, or non-transitory computer-readable medium of any of aspects 1 through 6, where configuring the memory device for the operations in the first mode is based at least in part on an indication via the one or more first command/address terminals, the one or more second command/address terminals, or a combination thereof.

Aspect 8: The method, apparatus, or non-transitory computer-readable medium of any of aspects 1 through 7, where the first channel interface includes the one or more first command/address terminals, one or more first clock terminals associated with the one or more first command/address terminals, and one or more first data terminals associated with the one or more first command/address terminals and the second channel interface includes the one or more second command/address terminals, one or more second clock terminals associated with the one or more second command/address terminals, and one or more second data terminals associated with the one or more second command/address terminals.

Aspect 9: The method, apparatus, or non-transitory computer-readable medium of aspect 8, where configuring the memory device for the operations in the first mode includes operations, features, circuitry, logic, means, or instructions, or any combination thereof for configuring the memory device to decode the access commands in the first mode based at least in part on latching of the first command/address terminals and the second command/address terminals that is aligned with rising edges and falling edges of the first clock signal or the second clock signal.

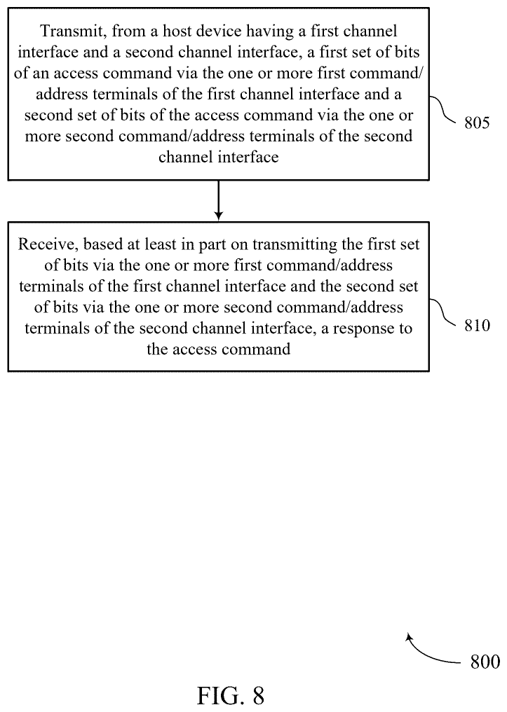

FIG. 8 shows a flowchart illustrating a method 800 that supports interface techniques for multi-channel memory devices in accordance with examples as disclosed herein. The operations of method 800 may be implemented by a host system or its components as described herein. For example, the operations of method 800 may be performed by a host system as described with reference to FIGS. 1 through 3 and 6. In some examples, a host system may execute a set of instructions to control the functional elements of the device to perform the described functions. Additionally, or alternatively, the host system may perform aspects of the described functions using special-purpose hardware.

At 805, the method may include transmitting, from a host device having a first channel interface and a second channel interface, a first set of bits of an access command via the one or more first command/address terminals of the first channel interface and a second set of bits of the access command via the one or more second command/address terminals of the second channel interface. In some examples, aspects of the operations of 805 may be performed by a command manager 625 as described with reference to FIG. 6.

At 810, the method may include receiving, based at least in part on transmitting the first set of bits via the one or more first command/address terminals of the first channel interface and the second set of bits via the one or more second command/address terminals of the second channel interface, a response to the access command. In some examples, aspects of the operations of 810 may be performed by an access manager 630 as described with reference to FIG. 6.

In some examples, an apparatus as described herein may perform a method or methods, such as the method 800. The apparatus may include features, circuitry, logic, means, or instructions (e.g., a non-transitory computer-readable medium storing instructions executable by a processor), or any combination thereof for performing the following aspects of the present disclosure:

Aspect 10: A method, apparatus, or non-transitory computer-readable medium including operations, features, circuitry, logic, means, or instructions, or any combination thereof for transmitting, from a host device having a first channel interface and a second channel interface, a first set of bits of an access command via the one or more first command/address terminals of the first channel interface and a second set of bits of the access command via the one or more second command/address terminals of the second channel interface and receiving, based at least in part on transmitting the first set of bits via the one or more first command/address terminals of the first channel interface and the second set of bits via the one or more second command/address terminals of the second channel interface, a response to the access command.

Aspect 11: The method, apparatus, or non-transitory computer-readable medium of aspect 10, further including operations, features, circuitry, logic, means, or instructions, or any combination thereof for transmitting, from the host device, a third set of bits of a second access command via the one or more first command/address terminals of the first channel interface and receiving, based at least in part on transmitting the third set of bits via the one or more first command/address terminals of the first channel interface, a second response to the second access command.

Aspect 12: The method, apparatus, or non-transitory computer-readable medium of aspect 11, where the first set of bits and the second set of bits are transmitted in accordance with rising edges and falling edges of a clock signal conveyed via a clock terminal of the first channel interface and the third set of bits are transmitted in accordance with rising edges of the clock signal conveyed via the clock terminal of the first channel interface.

Aspect 13: The method, apparatus, or non-transitory computer-readable medium of any of aspects 10 through 12, where the first channel interface includes the one or more first command/address terminals, one or more first clock terminals associated with the one or more first command/address terminals, and one or more first data terminals associated with the one or more first command/address terminals, and the second channel interface includes the one or more second command/address terminals, one or more second clock terminals associated with the one or more second command/address terminals, and one or more second data terminals associated with the one or more second command/address terminals.

It should be noted that the aspects described herein describe possible implementations, and that the operations and the steps may be rearranged or otherwise modified and that other implementations are possible. Further, portions from two or more of the methods may be combined.

An apparatus is described. The following provides an overview of aspects of the apparatus as described herein:

Aspect 14: A memory device, including: a plurality of memory arrays; a first channel interface operable to access one or more of the plurality of memory arrays; a second channel interface operable to access one or more of the plurality of memory arrays; and processing circuitry coupled with the plurality of memory arrays, the first channel interface, and the second channel interface, the processing circuitry operable to cause the memory device to: configure the memory device for first operations in a first mode in which the memory device decodes first access commands communicated using one or more first command/address terminals of the first channel interface and decodes second access commands communicated using one or more second command/address terminals of the second channel interface; and configure the memory device for second operations in a second mode in which the memory device decodes third access commands communicated using the one or more first command/address terminals of the first channel interface and the one or more second command/address terminals of the second channel interface.

Aspect 15: The memory device of aspect 14, where the processing circuitry is operable to cause the memory device to: decode the first access commands and the second access commands in the first mode in accordance with a first quantity of clock cycles at the memory device; and decode the third access commands in the second mode in accordance with a second quantity of clock cycles at the memory device that is less than the first quantity of clock cycles.

Aspect 16: The memory device of any of aspects 14 through 15, where the processing circuitry is operable to cause the memory device to: decode the first access commands in the first mode based at least in part on latching of the first command/address terminals that is aligned with rising edges of a first clock signal; decode the second access commands in the first mode based at least in part on latching of the second command/address terminals that is aligned with rising edges of a second clock signal; decode the third access commands in the second mode based at least in part on latching of the first command/address terminals and the second command/address terminals that is aligned with a rising edges and falling edges of a third clock signal.

Aspect 17: The memory device of aspect 16, where the processing circuitry is operable to cause the memory device to: receive the first clock signal in the first mode via a first clock terminal of the first channel interface; receive the second clock signal in the first mode via a second clock terminal of the second channel interface; and receive the third clock signal in the second mode via the first clock terminal or the second clock terminal.

Aspect 18: The memory device of any of aspects 16 through 17, where the processing circuitry is operable to cause the memory device to: perform access operations in the first mode in accordance with a first delay between a first access operation and a second operation, the first delay associated with a first quantity of clock cycles; and perform access operations in the second mode in accordance with a second delay between the first access operation and the second access operation, the second delay associated with a second quantity of clock cycles that is less than the first quantity of clock cycles.

Aspect 19: The memory device of any of aspects 16 through 18, where the processing circuitry is operable to cause the memory device to: perform access operations in the first mode in accordance with a first delay between a read command and responsive data, the first delay associated with a first quantity of clock cycles; and perform access operations in the second mode in accordance with a second delay between the read command and responsive data, the second delay associated with a second quantity of clock cycles that is less than the first quantity of clock cycles.

Aspect 20: The memory device of any of aspects 16 through 19, where the processing circuitry is operable to cause the memory device to: perform first access operations responsive to the first access commands in the first mode in accordance with a first internal clock signal, the first internal clock signal based at least in part on applying a clock division to a first clock signal received via a first clock terminal of the first channel interface; perform second access operations responsive to the second access commands in the first mode in accordance with a second internal clock signal, the second internal clock signal based at least in part on applying the clock division to a second clock signal received via a second clock terminal of the second channel interface; perform third access operations responsive to the third access commands in the second mode in accordance with a third internal clock signal, the third internal clock signal based at least in part on a third clock signal received via the first clock terminal or the second clock terminal without an applied clock division.

Aspect 21: The memory device of any of aspects 14 through 20, where the processing circuitry is operable to cause the memory device to: configure the memory device for the second operations in the second mode based at least in part on an indication of an evaluation condition of the memory device.

Aspect 22: The memory device of any of aspects 14 through 21, where the plurality of memory arrays, the first channel interface, the second channel interface, and the processing circuitry are included in a first semiconductor die, the memory device further including a second semiconductor die, the second semiconductor die including: a second plurality of memory arrays; a third channel interface operable to access one or more of the second plurality of memory arrays; a fourth channel interface operable to access one or more of the second plurality of memory arrays; and second processing circuitry coupled with the second plurality of memory arrays, the third channel interface, and the fourth channel interface, the second processing circuitry operable to cause the memory device to: configure the memory device for third operations in the first mode in which the memory device decodes fourth access commands communicated using one or more third command/address terminals of the third channel interface and decodes fifth access commands using one or more fourth command/address terminals of the fourth channel interface; and configure the memory device for fourth operations in the second mode in which the memory device decodes sixth access commands communicated using the one or more third command/address terminals of the third channel interface and the one or more fourth command/address terminals of the fourth channel interface.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to condition of moving from an open-circuit relationship between components in which signals are not presently capable of being communicated between the components (e.g., over a conductive path) to a closed-circuit relationship between components in which signals are capable of being communicated between components (e.g., over the conductive path). When a component, such as a controller, couples other components together, the component may initiate a change that allows signals to flow between the other components over a conductive path that previously did not permit signals to flow.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory device, comprising:
a plurality of memory arrays;
a first channel interface operable to access one or more of the plurality of memory arrays;
a second channel interface operable to access one or more of the plurality of memory arrays; and
processing circuitry coupled with the plurality of memory arrays, the first channel interface, and the second channel interface, the processing circuitry operable to cause the memory device to:
configure the memory device for first operations in a first mode in which the memory device decodes first access commands communicated using one or more first command/address terminals of the first channel interface and decodes second access commands communicated using one or more second command/address terminals of the second channel interface; and
configure the memory device for second operations in a second mode in which the memory device decodes third access commands communicated using the one or more first command/address terminals of the first channel interface and the one or more second command/address terminals of the second channel interface.

2. The memory device of claim 1, wherein the processing circuitry is operable to cause the memory device to:
decode the first access commands and the second access commands in the first mode in accordance with a first quantity of clock cycles at the memory device; and
decode the third access commands in the second mode in accordance with a second quantity of clock cycles at the memory device that is less than the first quantity of clock cycles.

3. The memory device of claim 1, wherein the processing circuitry is operable to cause the memory device to:
decode the first access commands in the first mode based at least in part on latching of the one or more first command/address terminals that is aligned with rising edges of a first clock signal;
decode the second access commands in the first mode based at least in part on latching of the one or more second command/address terminals that is aligned with rising edges of a second clock signal; and
decode the third access commands in the second mode based at least in part on latching of the one or more first command/address terminals and the one or more second command/address terminals that is aligned with rising edges and falling edges of a third clock signal.

4. The memory device of claim 3, wherein the processing circuitry is operable to cause the memory device to:
receive the first clock signal in the first mode via a first clock terminal of the first channel interface;
receive the second clock signal in the first mode via a second clock terminal of the second channel interface; and
receive the third clock signal in the second mode via the first clock terminal or the second clock terminal.

5. The memory device of claim 3, wherein the processing circuitry is operable to cause the memory device to:
perform access operations in the first mode in accordance with a first delay between a first access operation and a second access operation, the first delay associated with a first quantity of clock cycles; and
perform access operations in the second mode in accordance with a second delay between the first access operation and the second access operation, the second delay associated with a second quantity of clock cycles that is less than the first quantity of clock cycles.

6. The memory device of claim 3, wherein the processing circuitry is operable to cause the memory device to:
perform access operations in the first mode in accordance with a first delay between a read command and responsive data, the first delay associated with a first quantity of clock cycles; and
perform access operations in the second mode in accordance with a second delay between the read command and responsive data, the second delay associated with a second quantity of clock cycles that is less than the first quantity of clock cycles.

7. The memory device of claim 3, wherein the processing circuitry is operable to cause the memory device to:
perform first access operations responsive to the first access commands in the first mode in accordance with a first internal clock signal, the first internal clock signal based at least in part on applying a clock division to the first clock signal received via a first clock terminal of the first channel interface;
perform second access operations responsive to the second access commands in the first mode in accordance with a second internal clock signal, the second internal clock signal based at least in part on applying the clock division to the second clock signal received via a second clock terminal of the second channel interface; and
perform third access operations responsive to the third access commands in the second mode in accordance with a third internal clock signal, the third internal clock signal based at least in part on the third clock signal received via the first clock terminal or the second clock terminal without an applied clock division.

8. The memory device of claim 1, wherein the processing circuitry is operable to cause the memory device to:
configure the memory device for the second operations in the second mode based at least in part on an indication of an evaluation condition of the memory device.

9. The memory device of claim 1, wherein the plurality of memory arrays, the first channel interface, the second channel interface, and the processing circuitry are included in a first semiconductor die, the memory device further comprising a second semiconductor die, the second semiconductor die comprising:
a second plurality of memory arrays;
a third channel interface operable to access one or more of the second plurality of memory arrays;
a fourth channel interface operable to access one or more of the second plurality of memory arrays; and
second processing circuitry coupled with the second plurality of memory arrays, the third channel interface, and the fourth channel interface, the second processing circuitry operable to cause the memory device to:
configure the memory device for third operations in the first mode in which the memory device decodes fourth access commands communicated using one or more third command/address terminals of the third channel interface and decodes fifth access commands using one or more fourth command/address terminals of the fourth channel interface; and
configure the memory device for fourth operations in the second mode in which the memory device decodes sixth access commands communicated using the one or more third command/address terminals of the third channel interface and the one or more fourth command/address terminals of the fourth channel interface.

10. A method of operating a memory device, comprising:
configuring the memory device, having a plurality of memory arrays, a first channel interface, and a second channel interface, for operations in a first mode in which the memory device decodes access commands communicated using one or more first command/address terminals of the first channel interface and one or more second command/address terminals of the second channel interface;
receiving, based at least in part on configuring the memory device for the operations in the first mode, a first set of bits of an access command via the one or more first command/address terminals of the first channel interface and a second set of bits of the access command via the one or more second command/address terminals of the second channel interface; and
performing, based at least in part on receiving the first set of bits via the one or more first command/address terminals of the first channel interface and receiving the second set of bits via the one or more second command/address terminals of the second channel interface, an access operation on a memory array of the plurality of memory arrays.

11. The method of claim 10, wherein configuring the memory device for the operations in the first mode comprises:
configuring the memory device to decode the access commands in the first mode based at least in part on a first clock signal received via a first clock terminal of the first channel interface or a second clock signal received via a second clock terminal of the second channel interface.

12. The method of claim 11, wherein configuring the memory device for the operations in the first mode comprises:
configuring the memory device to decode the access commands in the first mode based at least in part on latching of the one or more first command/address terminals and the one or more second command/address terminals that is aligned with rising edges and falling edges of the first clock signal or the second clock signal.

13. The method of claim 10, further comprising:
configuring the memory device for second operations in a second mode in which the memory device decodes second access commands communicated using the one or more first command/address terminals of the first channel interface;
receiving, based at least in part on configuring the memory device for the second operations in the second mode, a third set of bits of a second access command via the one or more first command/address terminals of the first channel interface; and
performing, based at least in part on receiving the third set of bits via the one or more first command/address terminals of the first channel interface, a second access operation on a second memory array of the plurality of memory arrays.

14. The method of claim 13, wherein configuring the memory device for the second operations in the second mode comprises:
configuring the memory device to decode the second access commands in the second mode based at least in part on a first clock signal received via a first clock terminal of the first channel interface.

15. The method of claim 14, wherein configuring the memory device for the second operations in the second mode comprises:
configuring the memory device to decode the second access commands in the second mode based at least in part on latching of the one or more first command/address terminals that is aligned with rising edges of the first clock signal.

16. The method of claim 10, wherein configuring the memory device for the operations in the first mode is based at least in part on an indication of an evaluation condition of the memory device.

17. The method of claim 10, wherein configuring the memory device for the operations in the first mode is based at least in part on an indication via the one or more first command/address terminals, the one or more second command/address terminals, or a combination thereof.

18. The method of claim 10, wherein:
the first channel interface comprises the one or more first command/address terminals, one or more first clock terminals associated with the one or more first command/address terminals, and one or more first data terminals associated with the one or more first command/address terminals; and
the second channel interface comprises the one or more second command/address terminals, one or more second clock terminals associated with the one or more second command/address terminals, and one or more second data terminals associated with the one or more second command/address terminals.

19. A method of operating a host device, comprising:
transmitting, from the host device having a first channel interface and a second channel interface, a first set of bits of an access command via one or more first command/address terminals of the first channel interface and a second set of bits of the access command via one or more second command/address terminals of the second channel interface; and
receiving, based at least in part on transmitting the first set of bits via the one or more first command/address terminals of the first channel interface and the second set of bits via the one or more second command/address terminals of the second channel interface, a response to the access command.

20. The method of claim 19, further comprising:
transmitting, from the host device, a third set of bits of a second access command via the one or more first command/address terminals of the first channel interface; and
receiving, based at least in part on transmitting the third set of bits via the one or more first command/address terminals of the first channel interface, a second response to the second access command.

21. The method of claim 20, wherein:
the first set of bits and the second set of bits are transmitted in accordance with rising edges and falling edges of a clock signal conveyed via a clock terminal of the first channel interface, and the third set of bits are transmitted in accordance with rising edges of the clock signal conveyed via the clock terminal of the first channel interface.

22. The method of claim 19, wherein:
the first channel interface comprises the one or more first command/address terminals, one or more first clock terminals associated with the one or more first command/address terminals, and one or more first data terminals associated with the one or more first command/address terminals; and
the second channel interface comprises the one or more second command/address terminals, one or more second clock terminals associated with the one or more second command/address terminals, and one or more second data terminals associated with the one or more second command/address terminals.
